(19) United States
(12) Patent Application Publication
(10) Pub. No.: US 2026/0295830 A1
(43) Pub. Date: Oct. 1, 2026

(54) PARAMETER SETTING DEVICE, PARAMETER SETTING METHOD, AND PARAMETER SETTING PROGRAM

(71) Applicant: Fanuc Corporation, Minamitsuru-gun, Yamanashi (JP)

(72) Inventor: Tomoki KATO, Minamitsuru-gun, Yamanashi (JP)

(73) Assignee: Fanuc Corporation, Minamitsuru-gun, Yamanashi (JP)

(21) Appl. No.: 19/479,197

(22) PCT Filed: Jun. 14, 2023
(86) PCT No.: PCT/JP2023/022102

§ 371 Date: Oct. 27, 2025

(51) Int. Cl. B25J 9/16; H04L 61/103

(52) U.S. Cl. CPC B25J 9/1656; H04L 61/103

(57) ABSTRACT

To provide a parameter setting device capable of easily setting a parameter in the field network of a robot control device. This parameter setting device sets the parameter of a connection external device connected to a robot control device via a network, and comprises a vendor specification unit, a parameter temporary setting unit, and a parameter determination unit. The vendor specification unit specifies the vendor of the connection external device. The parameter temporary setting unit temporarily sets the parameter of at least one external device by referring to a correspondence table in which at least one external device provided by the specified vendor and a parameter specific to each external device are associated with each other. The parameter determination unit determines a connection parameter corresponding to the connection external device on the basis of a response from the connection external device to the temporarily set parameter.

### CROSS REFERENCE TO RELATED APPLICATION

This is the U.S. National Phase application of PCT/JP 2023/022102, filed Jun. 14, 2023, the disclosure of this application being incorporated herein by reference in its entirety for all purposes.

### FIELD OF THE INVENTION

The present disclosure relates to a parameter setting device, a parameter setting method, and a parameter setting program.

### BACKGROUND OF THE INVENTION

Conventionally, for example, there is a protocol in which a parameter input of an external device (communication device) is required in a field network of a robot controller. In such a case, for example, parameters specific to the external device are input from the robot controller or a robot teaching operation panel or the like connected to the robot controller, and are set to the robot controller.

However, since the parameters are unique to each device, a setting work of the parameters input from the robot controller and the robot teaching operation panel requires, for example, referring to a manual, etc., and requires time and effort.

Conventionally, when communicating with an external device connected to a network, various proposals have been made as techniques relating to parameter settings for effectively communicating with the external device.

### PATENT LITERATURE

[PTL 1] Japanese Unexamined Patent Publication (Kokai) No. 2008-282342
[PTL 2] Japanese Unexamined Patent Publication (Kokai) No. 2022-138072
[PTL 3] Japanese Unexamined Patent Publication (Kokai) No. 2021-181124

### SUMMARY OF THE INVENTION

### Technical Problem

As described above, for example, in the field network of the robot controller, it may be required to set the parameters of the external device to the robot controller, but the parameter setting work requires time and effort. Specifically, a worker (operator, user) refers to, for example, a manual of the external device to be used, and inputs parameters of the external device described in the manual from a robot teaching operation panel or the like, thereby setting parameters of the external device to the robot controller.

As described above, since the setting work of the parameters input from the robot teaching operation panel or the like is unique to the external device to be used, and therefore places a heavy burden on the operator.

Therefore, there is a demand for a parameter setting device, a parameter setting method, and a parameter setting program with which it is possible to easily perform parameter setting in a field network of a robot controller.

According to an embodiment of the present invention, there is provided a parameter setting device for setting a parameter of a connection external device connected to a robot controller via a network, comprising a vendor specification unit, a parameter temporary setting unit, and a parameter determination unit.

The vendor specification unit is configured to specify a vendor of the connection external device. The parameter temporary setting unit is configured to temporarily set parameters of a plurality of external devices with reference to a correspondence table in which at least one external device provided by the specified vendor and a parameter unique to each of the external devices are associated with each other. The parameter determination unit is configured to determine a connection parameter corresponding to the connection external device based on a response from the connection external device with respect to the. temporarily set parameters.

The objects and effects of the present invention will be recognized and obtained by using the components and combinations specified in the claims. Both the general description as above and the detailed description below are exemplary and descriptive, and do not limit the invention described in the claims.

### BRIEF DESCRIPTION OF DRAWINGS

FIG. 1 is a block diagram schematically depicting an overall configuration of an example of a robot system.

FIG. 2 is an example of a screen for setting an EtherNet/IP® in a field network of a robot controller.

FIG. 3 is a block diagram schematically depicting an example of a robot system to which a first example of a parameter setting device according to the present embodiment is applied.

FIG. 4 is a functional block diagram for explaining the parameter setting device according to the first embodiment depicted in FIG. 3.

FIG. 5 is a diagram for explaining a structure example of an ARP packet.

FIG. 6 is a diagram depicting an example of a captured ARP packet.

FIG. 7 is a flowchart for explaining an example of processing in one embodiment of a parameter setting program according to the present embodiment.

FIG. 8 is a block diagram schematically depicting an example of a robot system to which a second example of a parameter setting device according to the present embodiment is applied.

FIG. 9 is a functional block diagram for explaining the parameter setting device of the second embodiment depicted in FIG. 8.

### DETAILED DESCRIPTION OF EMBODIMENTS OF THE INVENTION

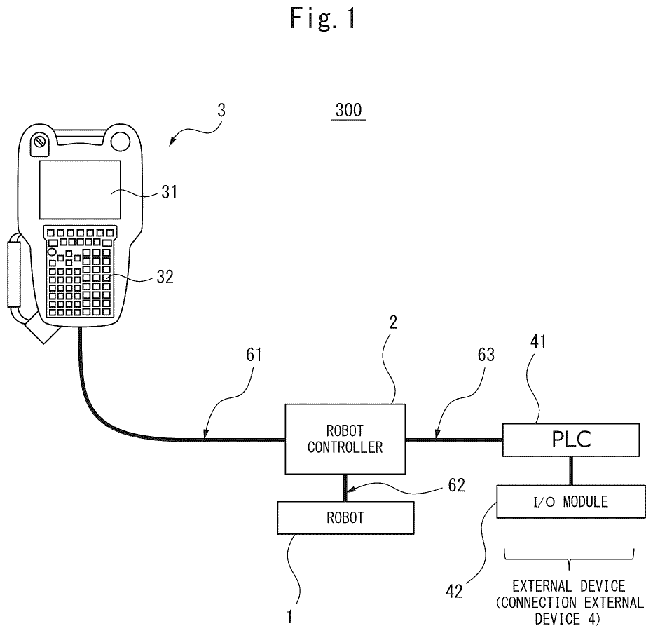

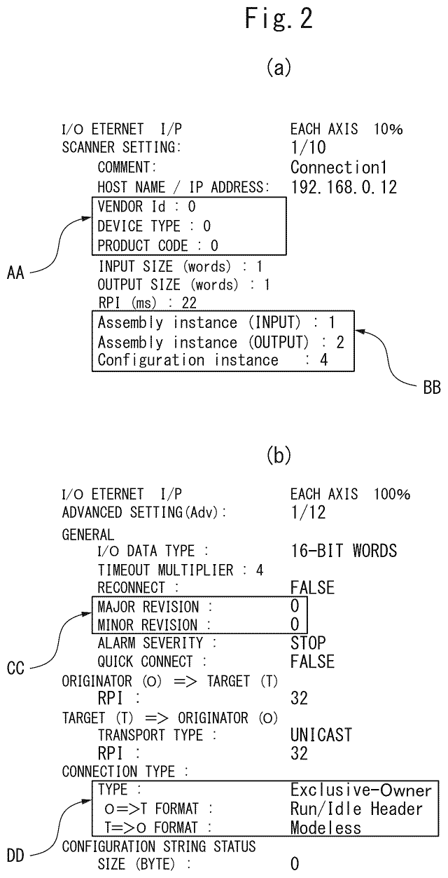

First, a parameter setting device, a parameter setting method, and a parameter setting program according to the present embodiment will be described with reference to FIG. 1 and FIG. 2, and the parameter setting of an external device (connection external device) connected to a robot controller via a network will be described. FIG. 1 is a block diagram schematically depicting an overall configuration of an example of a robot system, and is for describing a parameter setting of a connection external device 4 connected to a robot controller 2 via a network 63.

As depicted in FIG. 1, a robot system 300 includes a robot 1, a robot controller 2, a robot teaching operation panel 3, and a connection external device (external device) 4. Note that the external device 4 is, for example, a programmable logic controller (PLC) 41 or I/O module (Input/Output Module) 42 or the like is not limited thereto.

A cable 61 that connects the robot teaching operation panel 3 and the robot controller 2, and a cable (communication cable) 63 that connects the robot controller 2 and the connection external device 4 are, for example, complying with an ETHERNET/EtherNet®. Note that the cable 62 connecting the robot controller 2 and the robot 1 is, for example, dedicated.

The robot teaching operation panel 3 includes, for example, a display unit 31 such as a liquid crystal display and a keyboard (including various operation buttons) 32, and an operator (worker) operates the keyboard 32 while confirming the display unit 31 to perform operation control and various settings of the robot 1.

Incidentally, for example, when the PLC 41 is used by connecting it to the robot controller 2 via the cable 63, the PLC 41 may not be used unless parameters specific to the PLC 41 are set in the robot controller 2. Therefore, the operator, for example, refers to a manual for the PLC 41 to be used, and operates the keyboard 32 while checking the display unit 31 of the robot teaching operation panel 3 to set the parameters specific to the PLC 41 to the robot controller 2.

Note that, when the robot system 300 does not include the robot teaching operation panel 3 and the display unit 31 and the keyboard 32 are provided in the robot controller 2, the operator refers to, for example, the manual of the PLC 41 to be used, and operates the keyboard 32 while confirming the display unit 31 of the robot controller 2 to set the parameters specific to the PLC 41 to the robot controller 2. The same applies to the case where the robot system 300 includes the robot teaching operation panel 3, and the display unit 31 and the keyboard 32 are provided in each of the robot teaching operation panel 3 and the robot controller 2. Further, the connection external device 4 is not limited to the PLC 41 as described above.

FIG. 2 is an example of a screen for setting an EtherNet/IP® in a field network of a robot controller, FIG. 2(a) depicts an example of a screen for a scanner setting, and FIG. 2(b) depicts an example of an advanced setting (Adv).

As depicted in reference character AA of FIG. 2(a), the scanner setting sets a “Vendor Id: 0”, a “Device type: 0” and a “Product code: 0”, and parameters of the connection external device 4, and as depicted in reference character BB, the scanner setting sets an “Assembly instance (input): 1”, an Assembly instance (output): 2” and a “Configuration instance: 4”, and parameters of the connection external device 4.

As depicted in reference character CC of FIG. 2(b), the advanced setting (Adv) sets a “Measure revision: 0” and a “Minor revision: 0”, and parameters of the connection external device 4, and as depicted in reference character DD of FIG. 2(b), the scanner setting sets a “Type: Exclusive-owner”, “O=>T Format: Run/Idle Header”, “T=>O Format: Mode less”, and parameters of the connection external device 4.

In this way, for example, when the connection external device 4 such as the PLC 41 is newly connected to the robot controller 2 via a network cable 63, the operator sets the parameters of the PLC 41 to the robot controller 2 by inputting a parameters specific to the PLC 41 from the robot teaching operation panel 3 or the like with reference to the manual or the like of the PLC 41. Since the setting work of the parameter input from the robot teaching operation panel 3 or the like is unique to the external device (connection external device) 4 to be used, a large burden is applied to the operator.

Hereinafter, examples of a parameter setting device, a parameter setting method, and a parameter setting program according to the present embodiment will be described in detail with reference to the accompanying drawings. In each drawing, the same or similar elements are denoted by the same or similar reference signs. Further, embodiments described below do not limit the technical scope of the invention described in the claims and the meaning of the term.

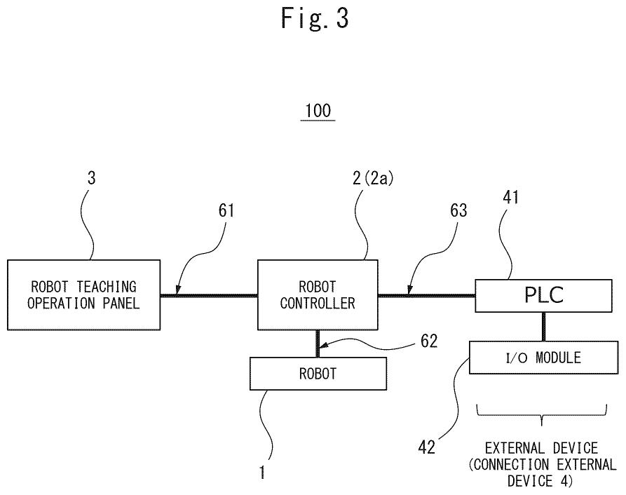

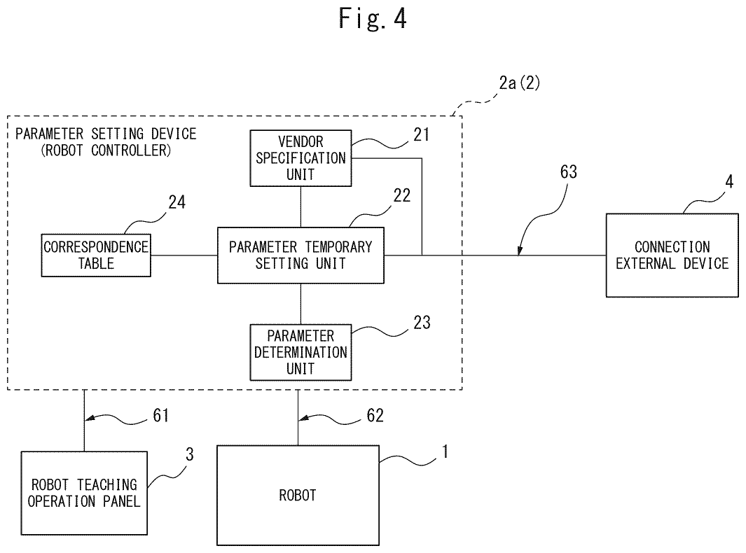

FIG. 3 is a block diagram schematically depicting an example of a robot system to which a first example of a parameter setting device according to the present embodiment is applied, and FIG. 4 is a functional block diagram for explaining the parameter setting device according to the first embodiment depicted in FIG. 3. The parameter setting device 2a according to the first embodiment is built into and integrally provided in the robot controller 2. Specifically, as depicted in FIG. 3, a robot system 100 includes a robot 1, a robot controller 2 (parameter setting device 2a), a robot teaching operation panel 3, and a connection external device 4.

Here, for example, when an external device (connection external device) 4 such as a PLC 41 or an I/O module 42 is used by connecting it to the robot controller 2 via a network (e.g., EtherNet®) 63, by applying the parameter setting device 2a of the first embodiment, the operator only needs to connect the PLC 41 or the I/O module 42 to one end of the network (cable) 63, the other end of which is connected to the robot controller 2. In other words, the operator does not need to perform the setting work of the parameters to be set in the robot controller 2 by inputting the parameters of the PLC 41 or the I/O module 42 output from the robot teaching operation panel 3 or the like.

As depicted in FIG. 4, the parameter setting device 2a of the first embodiment incorporated in the robot controller 2 includes a vendor specification unit 21, a parameter temporary setting unit 22, and a parameter determination unit 23. The vendor specification unit 21 identifies, for example, a vendor of a connected external device 4, such as a PLC 41 or an I/O module 42, connected to the robot controller 2 via a cable (network) 63, based on a MAC (Media Access Control) address in an ARP (Address Resolution Protocol) packet of the connected external device 4.

For example, the parameter temporary setting unit 22 temporarily sets parameters of at least one external device with reference to a correspondence table 24 stored in advance to a memory of the parameter setting device 2a (robot controller 2). Specifically, the parameter temporary setting unit 22 refers to the correspondence table 24, temporarily sets the parameter of at least one external device provided by the vendor, and then transmits the communication start packet to a connection external device 4.

Note that the correspondence table 24 is, for example, a table in which at least one external device provided by the vendor is associated with parameters unique to each external device, and is downloaded from a database such as a home page of each vendor and stored (memorized) in advance in the memory of the parameter setting device 2a. Specifically, in the correspondence table 24, for example, when the vendor provides a plurality of types of external devices, the parameters unique to the respective types of external devices are stored in association with each other, and if the external device provided by the vendor is one type, the parameters unique to the external device are stored in association with each other.

The parameter determination unit 23 determines connection parameters corresponding to the connection external device 4 based on a response from the connection external device 4 with respect to temporarily set parameters. Specifically, for example, when the parameter temporary setting unit 22 receives a success response from the connection external device 4 with respect to the communication start packet, the parameter determination unit 23 determines the temporarily set parameters as the connection parameters. In other words, when the communication start packet is transmitted based on the parameter temporarily set by the parameter temporary setting unit 22, if the temporarily set parameters are different from the parameter of the connection external device 4 in which the temporarily set parameter is actually connected, the response of the success may not be received, so that the parameter corresponding to the connection external device 4 may be determined.

In the above, the parameter setting device 2a including the vendor specification unit 21, the parameter temporary setting unit 22, and the parameter determination unit 23 may also be integrally provided in the robot teaching operation board 3 instead of the robot controller 2. The correspondence table 24 May also be stored in the memory of the robot teaching operation panel 3 instead of the robot controller 2.

As described above, by applying the parameter setting device 2a according to the first embodiment, for example, when the new external device is connected to the robot controller via a cable 63 as the connection external device 4, the parameter of the connection external device is automatically set to the robot controller 2. Specifically, the operator may use an external connection device 4 as it is without inputting parameters from the robot teaching operation panel 3 by referring to the manual of the external connection device 4, for example.

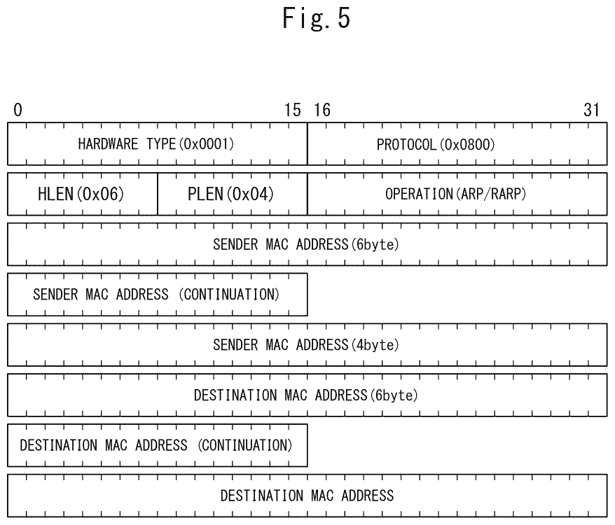

FIG. 5 is a diagram for explaining a structure example of an ARP packet. As depicted in FIG. 5, the structure of the ARP packet is very simple, and the packet is exchanged between the sender and the destination to exchange information on the respective IP (Internet Protocol) address and a MAC address. Note that the actual MAC address differs depending on the network, and FIG. 5 depicts the case of EtherNet® and stores a MAC address for 6 bytes (48 bits).

Specifically, the ARP is a protocol for determining the MAC address from the IP address, and a field for storing the IP address and the MAC address of the destination and the destination is prepared inside the packet. Note that RARP is a protocol (ReverseARP) for obtaining an IP address from a MAC address opposite to the ARP. In addition, the MAC address and the IP address have a variable length, and the length (byte length) is written to the HLEN and the PLEN, respectively. Specifically, in the case of EtherNet®, the HLEN is “6”, and PLEN is always “4” in IPv4 (Internet Protocol Version 4).

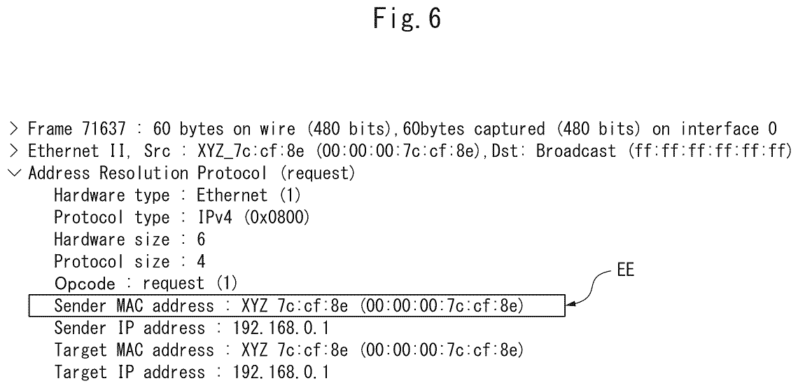

FIG. 6 is a diagram depicting an example of a captured ARP packet, and depicts a specific example of an ARP packet captured by packet capture software. As depicted in the reference sign EE of FIG. 6, for example, when the robot controller 2 and the connection external device (external device) 4 are connected by a network (e.g. EtherNet® cable 63) to perform communication, the vendor of the connection external device 4 may be specified by confirming the ARP packet of the connection external device 4. Specifically, it is specified from the ARP data “Sender MAC Address: XYZ 7c: cf8e (00: 00: 00: 7c: cf: 8e)”, for example, that the vendor of the connection external device 4 is an “XYZ company” represented by “00: 00: 00”.

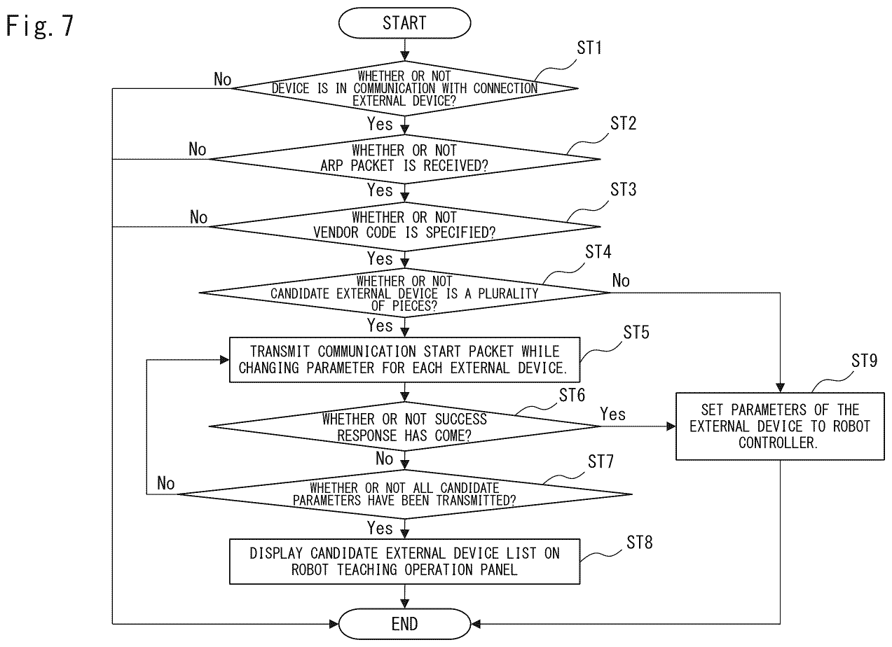

FIG. 7 is a flowchart for explaining an example of processing in one embodiment of a parameter setting program according to the present embodiment. As depicted in FIG. 7, when one example of the processing of the parameter setting program of the present embodiment starts (START), in step ST1, it is determined whether or not a device is in communication with a connection external device 4, and when it is determined that the device is in communication with the connection external device 4 (YES), it proceeds to step ST2 to determine whether or not an ARP packet has been received.

In step ST2, when it is determined that the ARP packet is received (YES), it proceeds to step ST3 to determine whether or not a vendor code is specified. In step ST3, when it is determined that the vendor code is specified (YES), the process proceeds to step ST4. That is, as described above, the vendor specification unit 21 specifies the vendor of the connection external device 4 based on the MAC address in the ARP packet of the connection external device 4, for example. When step ST1 is not in communication with the connection external device 4 (NO), the ARP packet is not received in step ST2 (NO), and when it is determined in step ST3 that the vendor code is not specified (NO), the processing is ended (END).

In step ST4, it is determined whether or not a candidate external device is a plurality of pieces, and when it is determined that the candidate external device is a plurality of pieces (YES), it proceeds to step ST5 and transmits the communication start packet while changing the parameter for each external device. That is, as described above, for example, the parameter temporary setting unit 22 refers to the correspondence table 24 stored in advance in the memory of the parameter setting device 2a, and transmits the communication start packet to the connection external device 4 in which the type is not determined yet while changing the parameters corresponding to the respective external devices in order for the plurality of external devices to be candidates.

Next, in step ST6, it is determined whether or not a success response has come, and when it is determined that the success response has come (YES), it proceeds to step ST9, and the parameter of the external device with which the successful response has come is set as a parameter of the connection external device 4 to the robot controller 2. Specifically, as described above, the parameter determination unit 23 transmits the communication start packet based on the parameter temporarily set by the parameter temporary setting unit 22, and receives a success response only when the temporarily set parameter matches the parameter of the connection external device 4 actually connected, so that the parameter of the connection external device 4 may be determined. Then, in step ST9, after setting the parameter of the external device having the successful response as the parameter of the external device 4 to the robot controller 2, the process is terminated (END).

Note that, in step ST4, when it is determined that there are not a plurality of external devices to be candidates (NO), that is, when the external device provided by the vendor is one type, the parameters of the one type of external device are set to the robot controller 2 as a parameter of the connection external device 4. In step ST6, when it is determined that there is no success response (NO), it proceeds to step ST7 to determine whether all the candidate parameters have been transmitted, and when it is determined that all the candidate parameters are not transmitted (NO), the process returns to step ST5 to repeat similar processing.

Specifically, in step ST7, when it is determined that all candidate parameters are transmitted (YES), the process proceeds to step ST8, and the candidate external device list is displayed on the robot teaching operation panel 3 to end (END) processing. Note that, when all candidate parameters are transmitted to the connection external device 4, the external device list of all the candidates is displayed on the display unit 31 of the robot teaching operation panel 3, for example, and notified to an operator. When the display unit (31) is also provided in the robot controller 2, the external device list of all the candidates is displayed on the display unit of the robot controller 2, or is displayed on both the display unit 31 of the robot teaching operation panel 3 and the display unit of the robot controller 2. Furthermore, the display unit 31 is not limited to displaying an external device list of all the candidates when all the candidate parameters have been transmitted. For example, the display unit 31 also displays information such as a parameter determined by the parameter determination unit 23 and a vendor or type of the connection external device 4 corresponding to the determined parameter.

Note that, one embodiment of the parameter setting program according to the present embodiment described above may be stored in a memory of the robot teaching operation panel 3 connected to, for example, a robot controller 2 or a robot controller, and may be executed by an arithmetic processing device (CPU) of the robot controller 2 or the robot teaching operation panel 3. Alternatively, one embodiment of the parameter setting program according to the present embodiment may be stored in a memory of a setting computer 5 different from the robot controller 2, for example, as described in detail below, and may also be executed by the arithmetic processing device of the setting computer 5.

The parameter setting program according to the above-described embodiment may be recorded and provided in a computer-readable non-transitory recording medium or a non-volatile semiconductor memory, or may be provided via wired or wireless. Here, the computer-readable non-transitory recording medium may be, for example, a CD-ROM (Compact Disc Read Only Memory), an optical disk such as a DVD-ROM, a hard disk device, and the like. In addition, a PROM (Programmable Read Only Memory), a flash memory, and the like are considered as the non-volatile semiconductor memory. Further, the distribution from the server device is considered to be provided via a wired or wireless LAN (Local Area Network), or a WAN (Wide Area Network) such as an Internet.

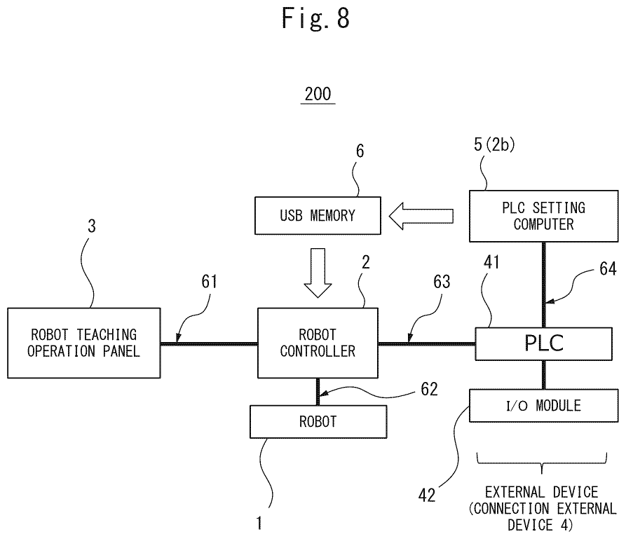

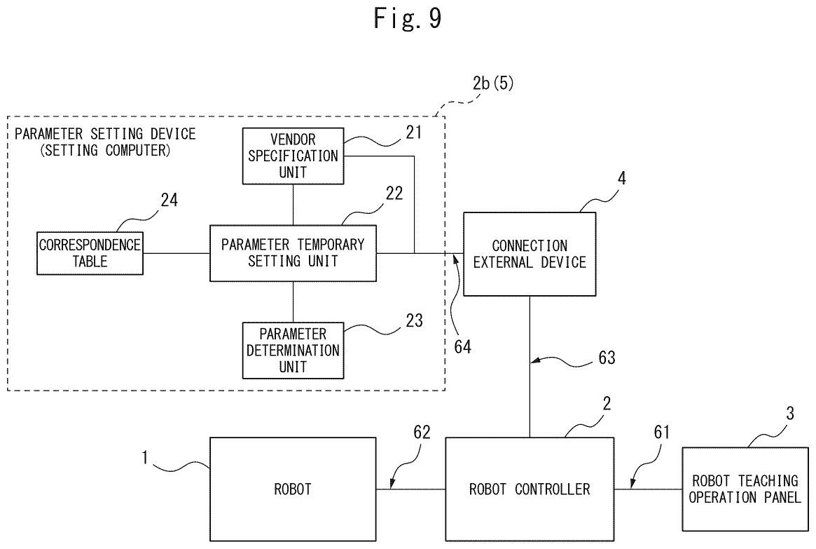

FIG. 8 is a block diagram schematically depicting an example of a robot system to which a second example of a parameter setting device according to the present embodiment is applied, and FIG. 9 is a functional block diagram for explaining the parameter setting device of the second embodiment depicted in FIG. 8. Note that the parameter setting device 2b according to the second embodiment is provided as a setting computer different from the robot controller 2. Specifically, as depicted in FIG. 8, a robot system 200 includes a robot 1, a robot controller 2, a PLC setting computer 5 (parameter setting device 2b), a robot teaching operation panel 3, and a connection external device 4. In FIG. 8 and FIG. 9, the setting computer functioning as the parameter setting device 2b is configured by the PLC setting computer 5 that performs various settings in a PLC 41, but is not limited to the PLC setting computer 5.

As is clear from the comparison between FIG. 9 and FIG. 4 described above, the parameter setting device 2b according to the second embodiment has a configuration similar to that of the parameter setting device 2a of the first embodiment. Specifically, the parameter setting device 2b according to the second embodiment is provided separately from the robot controller 2, and includes a vendor specification unit 21, a parameter temporary setting unit 22, and a parameter determination unit 23. Since these vendor specification unit 21, the parameter temporary setting unit 22, the parameter determination unit 23, and the correspondence table 24 are substantially similar to those in the parameter setting device 2a of the first embodiment, the description thereof will be omitted.

As depicted in FIG. 8 and FIG. 9, the PLC setting computer (setting computer) 5 is connected to the PLC 41 by, for example, a USB (Universal Serial Bus) cable 64, and performs various settings in the PLC 41. The parameter setting device 2b according to the second embodiment has a function similar to that of the parameter setting device 2a of the first embodiment by installing the parameter setting program according to the present embodiment described above with respect to the PLC setting computer 5. Note that, for example, a notebook personal computer, a tablet computer, and the like may be used as the parameter setting device 2b (setting computer 5). Further, although the parameter setting device 2b of the second embodiment may receive a success response to the communication start packet by the parameter temporary setting unit 22 from the PLC 41 via the USB cable 64, for example, the setting computer 5 (parameter setting device 2b) may also be connected to the PLC 41 via the EtherNet® cable 64.

The parameter setting device 2b of the second embodiment substantially stores the determined parameter of the connection external device 4 (PLC 41) obtained by performing the same processing as the parameter setting device 2a of the first embodiment described with reference to FIG. 3 to FIG. 7 in a USB memory 6. Further, the operator inserts the USB memory 6 in which the determined parameter of the connection external device 4 is stored into the USB terminal of the robot controller 2, and sets the parameter of the connection external device 4 to the robot controller 2. In this case, the operator performs the attachment/detachment work of the USB memory 6 that mediates between the setting computer 5 and the robot controller 2, but is, for example, a work that is easier than the parameter setting work performed by referring to the manual or the like of the connection external device 4. It should be noted that various modifications and modifications are possible, such as connecting the setting computer 5 and the robot controller 2 by a communication cable such as EtherNet® instead of using the USB memory 6. are not possible without using the USB memory 6.

As described above in detail, a parameter setting device, a parameter setting method, and a parameter setting program according to the present embodiment make it possible to easily set parameters in a field network of a robot controller.

Although the present disclosure has been described in detail, the present disclosure is not limited to the individual embodiments described above. These embodiments may be added, replaced, changed, partially deleted, or the like within a range that does not deviate from the gist of the present disclosure, or within a range that does not deviate from the spirit of the present disclosure derived from the content described in the claims and the equivalents thereof. These embodiments may also be implemented in combination. For example, in the above-described embodiment, the order of each operation and the order of each processing are depicted as an example, and are not limited to these. In addition, the same applies to the case where a numerical value or a mathematical expression is used in the description of the above-described embodiment.

With regard to the above-described embodiments and variations, the following descriptions are further disclosed.

### Appendix 1

A parameter setting device (2a, 2b) for setting parameters of a connection external device (4) connected to a robot controller (2) via a network (63), comprising:
a vendor specification unit (21) configured to specify a vendor of the connection external device (4);
a parameter temporary setting unit (22) configured to temporarily set parameters of a plurality of external devices with reference to a correspondence table (24) in which at least one external device provided by the specified vendor and parameters unique to each of the external devices are associated with each other, and
a parameter determination unit (23) configured to determine connection parameters corresponding to the connection external device (4) based on a response from the connection external device (4) with respect to the. temporarily set parameters.

### Appendix 2

The parameter setting device according to appendix 1, wherein
the parameter temporary setting unit (22) refers to the correspondence table (24), temporarily sets the parameters of at least one external device provided by the vendor while changing the parameters of the at least one external device provided by the vendor, transmits a communication start packet to the connection external device (4), and
the parameter determination unit (23) determines the temporarily set parameters as the connection parameters when the parameter temporary setting unit (22) receives a success response from the connection external device (4) with respect to the communication start packet,

### Appendix 3

The parameter setting device according to appendix 1 or 2, wherein
the vendor specification unit (21) specifies a vendor of the connection external device (4) based on an ARP packet from the connection external device (4).

### Appendix 4

The parameter setting device according to appendix 3, wherein
the vendor specification unit (21) specifies the vendor of the connection external device (4) based on a MAC address in the ARP packet from the connection external device (4).

### Appendix 5

The parameter setting device according to any one of appendixes 1 to 4, wherein
the correspondence table (24) is downloaded in advance from a database and stored in a memory of the parameter setting device.

### Appendix 6

The parameter setting device according to any one of appendixes 1 to 5, wherein
the parameter setting device (2a) is incorporated in the robot controller (2) and integrally provided.

### Appendix 7

The parameter setting device according to any one of appendixes 1 to 5, wherein
a robot teaching operation panel (3) is connected to the robot controller (2), and
the parameter setting device (2a) is built into and integrally provided in the robot teaching operation panel (3).

### Appendix 8

The parameter setting device according to appendix 6 or 7, wherein
the connection parameters determined by the parameter determination unit (23) are set to the robot controller (2).

### Appendix 9

The parameter setting device according to any one of appendixes 1 to 5, wherein
the parameter setting device (2b) is provided as a setting computer different from the robot controller (2).

### Appendix 10

The parameter setting device according to appendix 9, wherein
the connection parameters determined by the parameter determination unit (23) are set to the robot controller (2) via an external memory (5) that is attached to and detached from the setting computer (2b).

### Appendix 11

The parameter setting device according to any one of appendixes 1 to 10, wherein
the robot controller (2) controls operations of a robot (1), and
the external device (4) is a PLC (41) or an I/O module (42) connected to a network (63) connected to the robot controller (2).

### Appendix 12

A parameter setting method for setting parameters of a connection external device (4) connected to a robot controller (2) via a network (63),
a step of specifying a vendor of the connection external device (4),
a step of referring to a correspondence table (24) in which at least one external device (4) provided by the specified vendor and parameters unique to each of the external devices (4) are associated with each other,
a step of determining connection parameters corresponding to the connection external device (4) based on a response from the connection external device (4) with respect to temporarily set parameters, and
a step of setting the determined connection parameters in the robot controller (2).

### Appendix 13

The parameter setting method according to appendix 12, wherein
the step of temporarily setting the parameters refers to the correspondence table (24), transmits a communication start packet to the connection external device (4) after temporarily setting the parameters of at least one external device (4) provided by the vendor, and
the step of determining the connection parameters determines the temporarily set parameters as the connection parameters based on a success response from the connection external device (4) to the communication start packet.

### Appendix 14

A parameter setting program for setting parameters of a connection external device (4) connected to a robot controller (2) via a network (63),
the parameter setting program causing a calculation processing device to execute the parameter setting method according to appendix 12 or 13.

### REFERENCE SIGNS LIST

1 Robot
2 Robot Controller
2a Parameter Setting Device (Robot Controller)
2b Parameter Setting Device (Setting Computer)
3 Robot Teaching Control Panel
4 Connected External Device (External Device)
5 Setting Computer (PLC Setting Computer)
6 USB Memory
21 Vender Specification Unit
22 Parameter Temporary Setting Unit
23 Parameter Determination Unit
24 Correspondence Table
41 PLC
42 I/O Module
61 to 64 Cable
100, 200, 300 Robot System

1. A parameter setting device for setting parameters of a connection external device connected to a robot controller via a network, comprising:
a vendor specification unit configured to specify a vendor of the connection external device;
a parameter temporary setting unit configured to temporarily set parameters of a plurality of external devices with reference to a correspondence table in which at least one external device provided by the specified vendor and parameters unique to each of the external devices are associated with each other, and
a parameter determination unit configured to determine connection parameters corresponding to the connection external device based on a response from the connection external device with respect to the. temporarily set parameters.

2. The parameter setting device according to claim 1, wherein
the parameter temporary setting unit refers to the correspondence table, temporarily sets the parameters of at least one external device provided by the vendor while changing the parameters of the at least one external device provided by the vendor, transmits a communication start packet to the connection external device, and
the parameter determination unit determines the temporarily set parameters as the connection parameters when the parameter temporary setting unit receives a success response from the connection external device with respect to the communication start packet.

3. The parameter setting device according to claim 1, wherein
the vendor specification unit specifies a vendor of the connection external device based on an ARP packet from the connection external device.

4. The parameter setting device according to claim 3, wherein
the vendor specification unit specifies the vendor of the connection external device based on a MAC address in the ARP packet from the connection external device.

5. The parameter setting device according to claim 1, wherein
the correspondence table is downloaded in advance from a database and stored in a memory of the parameter setting device.

6. The parameter setting device according to claim 1, wherein
the parameter setting device is incorporated in the robot controller and integrally provided.

7. The parameter setting device according to claim 1, wherein
a robot teaching operation panel is connected to the robot controller, and
the parameter setting device is built into and integrally provided in the robot teaching operation panel.

8. The parameter setting device according to claim 6, wherein
the connection parameters determined by the parameter determination unit are set to the robot controller.

9. The parameter setting device according to claim 1, wherein
the parameter setting device is provided as a setting computer different from the robot controller.

10. The parameter setting device according to claim 9, wherein
the connection parameters determined by the parameter determination unit are set to the robot controller via an external memory that is attached to and detached from the setting computer.

11. The parameter setting device according to claim 1, wherein
the robot controller controls operations of a robot, and
the external device is a PLC or an I/O module connected to a network connected to the robot controller.

12. A parameter setting method for setting parameters of a connection external device connected to a robot controller via a network,
a step of specifying a vendor of the connection external device,
a step of referring to a correspondence table in which at least one external device provided by the specified vendor and parameters unique to each of the external devices are associated with each other,
a step of determining connection parameters corresponding to the connection external device based on a response from the connection external device with respect to temporarily set parameters, and
a step of setting the determined connection parameters in the robot controller.

13. The parameter setting method according to claim 12, wherein
the step of temporarily setting the parameters refers to the correspondence table, transmits a communication start packet to the connection external device after temporarily setting the parameters of at least one external device provided by the vendor, and
the step of determining the connection parameters determines the temporarily set parameters as the connection parameters based on a success response from the connection external device to the communication start packet.

14. A computer readable non-transitory tangible medium for storing a parameter setting program for setting parameters of a connection external device connected to a robot controller via a network,
the parameter setting program causing a calculation processing device to execute the parameter setting method according to claim 12.
